(19) United States
(12) Patent Application Publication
(10) Pub. No.: US 2024/0012730 A1
(43) Pub. Date: Jan. 11, 2024

(54) PROGRAM FLOW MONITORING FOR GATEWAY APPLICATIONS

(71) Applicant: HUAWEI TECHNOLOGIES CO., LTD., Shenzhen (CN)

(72) Inventors: Abdoul Aziz Kane, Munich (DE); Francisco FONS LLUIS, Munich (DE)

(21) Appl. No.: 18/472,065

(22) Filed: Sep. 21, 2023

Related U.S. Application Data
(63) Continuation of application No. PCT/EP2021/057268, filed on Mar. 22, 2021.

(51) Int. Cl. G06F 11/30; G06F 9/448

(52) U.S. Cl. CPC G06F 11/302; G06F 9/4498

(57) ABSTRACT

A program flow monitoring (PFM) device for a gateway (GW) device is provided. The PFM device comprises a configurable functional state machine (FSM) configured to model a behavior of a monitored processing stage of the GW device. The PFM device is configured to predict an expected behavior of the monitored processing stage in dependence of an input of the monitored processing stage and the behavioral model; compare the expected behavior with an actual behavior of the monitored processing stage based on an output of the monitored processing stage; and selectively generate a fault notification in dependence of a result of the comparison.

### CROSS-REFERENCE TO RELATED APPLICATIONS

This application is a continuation of International Application No. PCT/EP2021/057268, filed on Mar. 22, 2021, the disclosure of which is hereby incorporated by reference in its entirety.

### TECHNICAL FIELD

Embodiments of the present disclosure generally relate to diagnostic self-testing of functional safety of digital circuits, and in particular to a program flow monitoring (PFM) device for a gateway device, a method of operating such a PFM device, and a corresponding computer program.

### BACKGROUND ART

Automotive gateway electronic control units (ECUs) must be safeguarded against faults that endanger the correct execution of their gateway applications. In particular, faults that could lead to a part of the application, i.e., a program sequence, being stopped before it finishes executing or exceeding its allocated time budget, or that could lead to an unintended change in the program sequence execution order, must be detected.

Therefore, to detect faults in clocks or processing units, more specifically to interrupt handler and control logic (i.e., sequencer, coding and execution logic including flag, registers and stack control) of microcontroller units (MCUs), it is useful to implement mechanisms that monitor the correct execution of program sequences.

These mechanisms shall detect failure modes of semiconductor elements such as:
Clock frequency deviations
Clock period jitter
Omission of continuous interrupts
Incorrect interrupt executed
Wrong priority
Slow or interfered interrupt handling causing missed or delayed interrupts service
Wrong coding, wrong or no execution
Execution out of order
Execution too fast or too slow
Stack overflow/underflow

Indeed, to achieve the highest possible Automotive Safety Integrity Level (ASIL), semiconductor manufacturers and system integrators shall implement such program sequence monitoring mechanism.

Also, the Road Vehicle—Functional Safety standard, ISO 26262:2018, recommends, for best coverage of the above-mentioned failure modes, to implement a temporal and logical monitoring of program sequences.

Nowadays, temporal monitoring of program sequences is done with a hardware timeout or window watchdog. Logical monitoring, however, is done by software using features of an operating system when available. In some implementations, temporal monitoring and sometimes even logical monitoring is realized on an external chip.

An implementation of logical monitoring in software is very complex, because of many applications running in parallel in one single ECU. Logical monitoring shall be able to monitor the execution time and order of execution of all program sequences in an automotive ECU. It shall do so in all situations and all phases of the ECU, and shall consider all the vehicle dynamics and the environmental conditions to which the ECU is exposed to. Such a software is very costly in terms of processing power. Currently this requires adding further processing resources. This drawback is accentuated by the fact that this software is safety related and shall be executed redundantly on diverse CPU resources (e.g., lockstep CPU).

Moreover, this very complex and costly software is not reusable for another ECU without high porting efforts.

### SUMMARY

The present disclosure thus aims at providing a generic IP core for temporal and logical monitoring of a program or processing sequence executing on a gateway ECU or SoC.

A first aspect of the present disclosure relates to a program flow monitoring (PFM) device for a gateway (GW) device. The PFM device comprises: a configurable functional state machine configured to model a behavior of a monitored processing stage of the GW device. The PFM device is configured to predict an expected behavior of the monitored processing stage in dependence of an input of the monitored processing stage and the behavioral model; compare the expected behavior with an actual behavior of the monitored processing stage based on an output of the monitored processing stage; and selectively generate a fault notification in dependence of a result of the comparison.

A GW device as used herein may refer to a network function that allows traffic to flow from one discrete network to another, and that can operate at any of the seven functional layers of the open systems interconnection (OSI) model.

A behavior as used herein may refer to a model describing a processing function in terms of its expected processing times and/or expected processing results in dependence of a stimulus of the processing function, such as ingress traffic.

In an implementation of the first aspect, the expected behavior may comprise a temporal behavior of the monitored processing stage. The temporal behavior may depend on at least one of: a network topology and configurable expected processing types of the monitored processing stage, configurable expected processing times and margins of the expected processing types, and actual processing types and actual frame types as given by the input of the monitored processing stage.

In an implementation of the first aspect, the expected behavior may comprise a logical behavior of the monitored processing stage. The logical behavior may depend on an error control coding of the input of the monitored processing stage.

In an implementation of the first aspect, the PFM device may further be configured to associate a respective generated fault notification with a response.

In an implementation of the first aspect, the response may comprise routing the generated fault notification to an output terminal of the PFM device.

In an implementation of the first aspect, the response may further comprise forwarding the generated fault notification on a differential signaling transmission line connected to the output terminal.

In an implementation of the first aspect, the PFM device may further be configured to inject an error into the input of the monitored processing stage used by the FSM for prediction.

In an implementation of the first aspect, the injected error may comprise an inverted input of the monitored processing stage.

In an implementation of the first aspect, the PFM device may further comprise a further processing stage corresponding to an unmonitored processing stage of the GW device adjoining the monitored processing stage.

In an implementation of the first aspect, the PFM device may further be configured to receive a clock supply different from a clock domain of the GW device.

In an implementation of the first aspect, the PFM device may further be configured to receive a voltage supply different from of a voltage domain of the GW device.

A second aspect of the present disclosure relates to a method of operating a program flow monitoring device for a gateway device. The PFM device comprises a configurable functional state machine configured to model a behavior of a monitored processing stage of the GW device. The method comprises predicting an expected behavior of the monitored processing stage in dependence of an input of the monitored processing stage and the behavioral model; comparing the expected behavior with an actual behavior of the monitored processing stage based on an output of the monitored processing stage; and selectively generating a fault notification in dependence of a result of the comparison.

In an implementation of the second aspect, the method may be performed by the PFM device of the first aspect or any of its implementations.

A third aspect of the present disclosure relates to a computer program comprising executable instructions which, when executed by a processor, cause the processor to perform the method of the second aspect or any of its implementations.

The present disclosure provides a PFM device representing a generic IP core for temporal and logical monitoring of a program or processing sequence executing on a gateway ECU or SoC.

An IP core as used herein may refer to a reusable unit of digital logic, cell, or integrated circuit layout design that may be used as a building block in the design of application-specific integrated circuits (ASICs) or field-programmable gate arrays (FPGAs).

The PFM device is a fully capable ASIL D Safety Element out of Context (SEooC), or in other words, a system developed for an assumed context and not for a specific vehicle, OEM or industry. This means that engineering of non-reusable, complex and costly software could be replaced by a reusable and configurable digital hardware solution.

Automotive Safety Integrity Level (ASIL) as used herein may refer to a risk classification scheme defined by the ISO 26262 standard (Functional Safety for Road Vehicles). ASIL D dictates the highest integrity requirements on a product.

The PFM device is comprehensively configurable by the user via configuration registers.

The PFM device performs redundant processing using redundant and diverse input and output stages and diverse signal processing compared to the GW device.

The PFM device, by nature/design, eliminates the weaknesses of a SW-based implementation (freedom from interference, time determinism, etc.).

The PFM device avoids common cause failures (CCF) with respect to supply of clock and/or voltage.

A common cause failure (CCF) as used herein may refer to a failure where a plurality of items fails within a specified time such that the success of the system mission would be uncertain, and item failures result from a single shared cause and coupling factor (or mechanism).

### BRIEF DESCRIPTION OF DRAWINGS

The above-described aspects and implementations will now be explained with reference to the accompanying drawings, in which the same or similar reference numerals designate the same or similar elements.

The features of these aspects and implementations may be combined with each other unless specifically stated otherwise.

The drawings are to be regarded as being schematic representations, and elements illustrated in the drawings are not necessarily shown to scale. Rather, the various elements are represented such that their function and general purpose become apparent to those skilled in the art.

FIG. 1 illustrates a PFM device in accordance with the present disclosure in a context of a GW device;

FIG. 2 illustrates details of the PFM device in accordance with the present disclosure;

FIG. 3 illustrates a safety checking unit of the PFM device of FIGS. 1, 2;

FIG. 4 illustrates a functional state machine (FSM) of the PFM device of FIGS. 1, 2;

FIG. 5 illustrates a lookup table of a path calculation unit of the FSM of FIG. 4; and

FIG. 6 illustrates a flow diagram of a method in accordance with the present disclosure of operating a PFM device for a GW device.

### DETAILED DESCRIPTIONS OF DRAWINGS

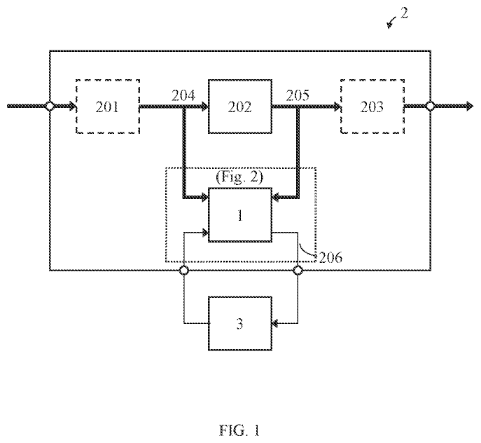

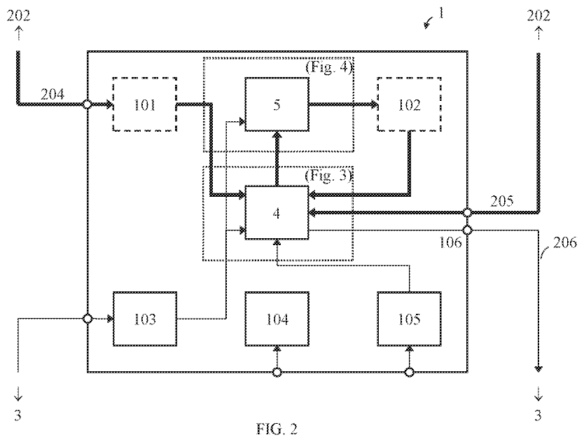

FIG. 1 illustrates a PFM device 1 in accordance with the present disclosure provided in a context of a GW device 2, and FIG. 2 illustrates details of the PFM device 1 in accordance with the present disclosure.

However, those skilled in the art will appreciate that the PFM device 1 may alternatively be provided inside a Safety MCU as well.

Besides the PFM device 1, the GW device 2 comprises a monitored processing stage 202, which is subjected to temporal and logical monitoring by the PFM device 1, and may further comprise unmonitored processing stages 201, 203. An optionality of the unmonitored processing stages 201, 203 is indicated by dashed lines in FIG. 1. For example, the monitored processing stage 202 may comprise a gateway function of GW devices, the unmonitored processing stage 201 may comprise ingress processing functions of GW devices such as frame normalizing, filtering, policing and/or ingress queueing, and the unmonitored processing stage 203 may comprise egress processing functions of a of GW devices such as frame denormalizing, crossbar switching, egress queueing and/or traffic shaping.

The PFM device 1 is designed as a fully capable ASIL D Safety Element out of Context (SEooC). As such, it may be instantiated multiple times within a same GW device for monitoring of multiple different monitored processing stages 202.

The PFM device 1 is configurable by a host processing unit 3 controlling the GW device 2 and is configured to notify the controlling host processing unit 3 of any faults.

In an operation phase, a frame received by the GW device 2 at one of a plurality (N) of input ports is network processed and forwarded to an appropriate one of a plurality (N) of output ports. In FIG. 1, only a representative one of the N 2 available data paths is shown. This representative data path is emphasized by thick lines in FIG. 1 and is formed by the unmonitored processing stage 201, if any, the monitored processing stage 202 as well as the unmonitored processing stage 203, if available. The PFM device 1 is configured to receive copies of an input 204 as well as an output 205 of the monitored processing stage 202 and processes the input 204 as configured by the host processing unit 3.

With reference to FIG. 2, the PFM device 1 comprises a configurable functional state machine (FSM) 5 configured to model a behavior of the monitored processing stage 202 of the GW device 2. Besides the FSM 5, the PFM device 1 may comprise further processing stages 101, 102 corresponding to any unmonitored processing stages 201, 203 of the GW device 2 adjoining the monitored processing stage 202. As such, the PFM device 1 may have redundant and diverse input and output stages 101, 102 and diverse signal processing compared to the GW device 2.

An output of the FSM 5 is compared to the output 205 of the monitored processing stage 202 of the GW device 2. More specifically, the PFM device 1 is configured to predict an expected behavior of the monitored processing stage 202 of the GW device 2 in dependence of an input 204 of the monitored processing stage 202 and the behavioral model of the FSM 5, and compare the expected behavior with an actual behavior of the monitored processing stage 202 of the GW device 2 based on an output 205 of the monitored processing stage 202.

The PFM device 1 is further configured to selectively generate a fault notification, in particular in dependence of a result of the comparison.

The PFM device 1 may further comprise a clock unit 104 and/or a power management unit 105 (see FIG. 1 for both) and be configured to receive a clock supply different from a clock domain of the GW device 2 and/or a voltage supply different from of a voltage domain of the GW device 2. As such, the PFM device 1 may belong to different clock and/or voltage domains than the GW device 2 it monitors for avoidance of CCFs.

The PFM device 1 may be configured to provide further GW safety mechanisms such as voltage and/or temperature monitoring. In case of faults, these safety mechanisms may generate alarms for their part.

The PFM device 1 may further comprise configuration registers 103 (see FIG. 1) for configurability of the PFM device 1. The configurable aspects of the PFM device include:
Configuration of input/output stage
   Number of input/output stages needed
   Type of processing (e.g., policing, filtering, queuing, etc.)
Configuration of fault notification
   Selection of the faults to be forwarded to the host processing unit
   Configuration of fault responses
Configuration of timers in the safety monitor
   Set up of timer frequencies and limits
   Configuration of fault injection
   Selection of input data (inverted input data or correct input data)
Configuration of the PFM FSM
   Expected processing type from host processing unit
   System/network topology information
   Set up of time margins for expected processing time
   Set up of Flow Health Monitoring parameters
   CRC calculation parameters

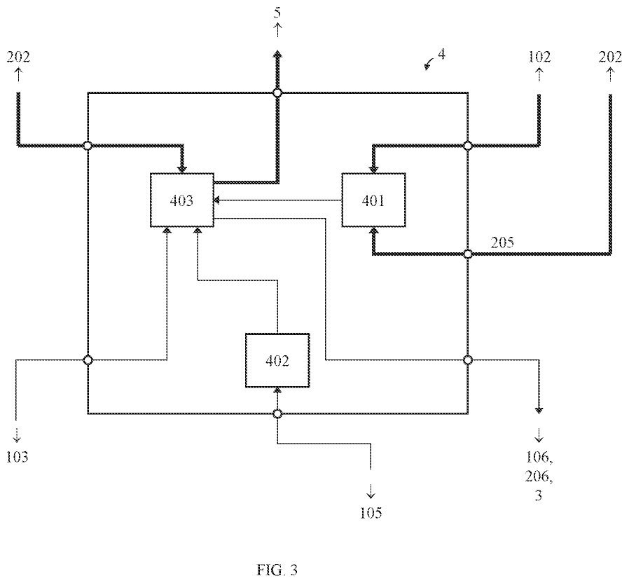

FIG. 3 illustrates a safety checking unit 4 of the PFM device 1 of FIGS. 1, 2.

The safety checking unit 4 of FIG. 3 comprises a PFM comparison unit 401, a voltage monitoring unit 402 and a safety monitoring unit 403.

The safety monitoring unit 403 receives the input 204 of the monitored processing stage 202 (see FIG. 1).

In order to detect mismatches between the output of the FSM 5 and the output 205 of the monitored processing stage 202 of the GW device 2, the PFM device 1 may further be configured to inject an error into the received input 204 of the monitored processing stage 202 and to be used by the FSM 5 for prediction. The injected error may comprise an inverted input 204 of the monitored processing stage 202 and be injected by the safety monitoring unit 403.

The safety monitoring unit 403 forwards the received input 204 of the monitored processing stage 202 to the FSM 5, irrespectively of any error injection.

The PFM comparison unit 401 receives the expected behavior of the monitored processing stage 202 of the GW device 2 predicted by the FSM 5 (see FIG. 2) in dependence of the input 204 of the monitored processing stage 202 and the behavioral model of the FSM The PFM comparison unit 401 further receives the output 205 of the monitored processing stage 202 representing the actual behavior of the monitored processing stage 202 of the GW device 2. The PFM comparison unit 401 is configured to compare the expected behavior with the actual behavior of the monitored processing stage 202, may signal an alarm to the safety monitoring unit 403 in dependence of a result of the comparison.

The voltage monitoring unit 402 may signal an alarm on its part to the safety monitoring unit 403 when detecting an improper voltage level supplied by the power management unit 105 (see FIG. 2).

The safety checking unit 4 may further be configured to control, among other features, an error pin/output terminal 106. When an alarm is raised, the PFM device 1 may selectively generate a fault notification. In this connection, the PFM device 1 may further be configured to associate a respective generated fault notification with a configurable response. The response may comprise routing the generated fault notification to the error pin/output terminal 106 of the PFM device 1 so as to notify the host processing unit 3 via the error pin 106.

The response may further comprise forwarding the generated fault notification on a differential signaling (i.e., inverted dual) transmission line 206 connected to the output terminal 106 to ensure that no fault notification will be lost because of a fault on the transmission line.

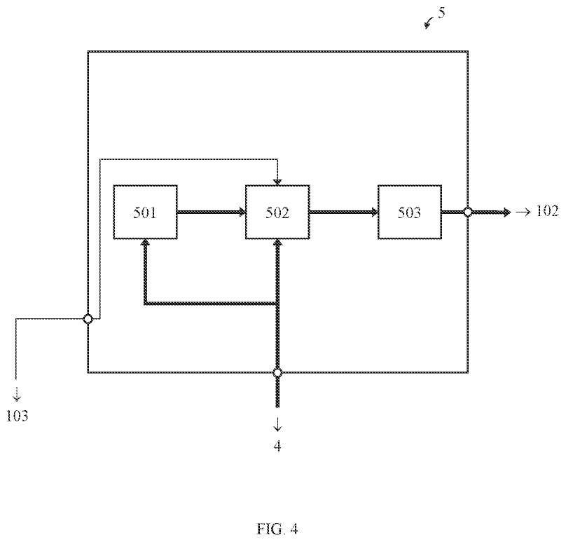

FIG. 4 illustrates an FSM 5 of the PFM device 1 of FIGS. 1, 2, and FIG. 5 illustrates a lookup table of a path calculation unit 502 of the FSM 5 of FIG. 4.

The FSM 5 implements a configurable diverse signal processing. In accordance with FIG. 4, the FSM 5 comprises a frame identification unit 501, a path calculation unit 502, and a frame buffering unit 503.

The frame identification unit 501 is configured to receive the input 204 of the monitored processing stage 202, and to identify a respective frame type of the received frames.

The frame buffering unit 503 is configured to re-synchronize the frames.

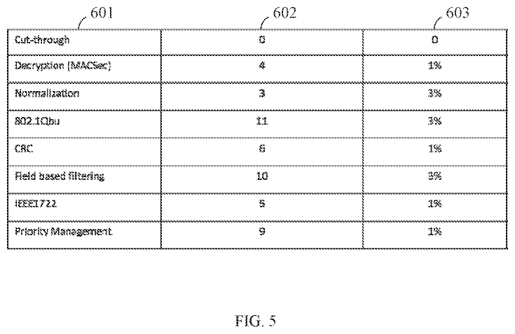

In between, the path calculation unit 502 is configured to receive the input 204 of the monitored processing stage 202 as well, and to match processing commands of the input 204 of the monitored processing stage 202 (more precisely, specific codes of a control bus of the GW device 2) against a list of expected processing types 601 (see FIG. 5 for examples) configured by the host processing unit 3.

For each one of the expected processing types 601, an expected processing/execution time 602 (for example, in clock cycles) and an expected processing time margin 603 (in %), if any, may be configured into a lookup table as shown in FIG. 5 in accordance with a known performance of the GW device 2 and the identified frame type. A known network topology and expected communication schedule may also be taken into account.

In other words, respective time budgets are calculated for the expected processing. Thus, the expected behavior may comprise a temporal behavior of the monitored processing stage 202. The temporal behavior may depend on at least one of: the network topology and the configurable expected processing types 601 of the monitored processing stage 202, the configurable expected processing times 602 and margins 603 of the expected processing types, and actual processing types and actual frame types as given by the input 204 of the monitored processing stage 202.

Based on the calculated time need of the various tasks handled by the GW device 2, a plurality of watchdog timers (not shown) of the safety monitoring unit 403 may be configured to reflect the expected execution/processing times 602. When a timer expires, an alarm may be raised.

Besides, the expected behavior may comprise a logical behavior of the monitored processing stage 202. The logical behavior may depend on an error control coding of the input 204 of the monitored processing stage 202. In particular, the FSM 5 may be configured to generate a cumulative cyclic redundancy check (CRC) checksum over the processing commands of the input 204 of the monitored processing stage 202.

While all these actions are being executed, a Flow Health Monitoring is done in parallel in the FSM 5 to ensure that the FSM 5 is not running into any issue.

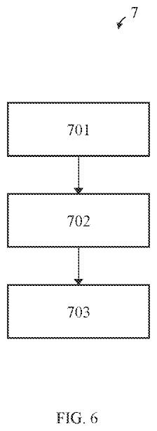

FIG. 6 illustrates a flow diagram of a method 7 in accordance with the present disclosure of operating a PFM device 1 for a GW device 2.

The PFM device 1 comprises a configurable functional state machine (FSM) 5 configured to model a behavior of a monitored processing stage 202 of the GW device 2.

The method 7 comprises a step of predicting 701 an expected behavior of the monitored processing stage 202 in dependence of an input 204 of the monitored processing stage 202 and the behavioral model.

The method 7 comprises a step of comparing 702 the expected behavior with an actual behavior of the monitored processing stage 202 based on an output 205 of the monitored processing stage 202.

The method 7 comprises a step of selectively generating 703 a fault notification in dependence of a result of the comparison.

The method 7 may be performed by the PFM device 1 of the first aspect or any of its implementations.

The technical effects and advantages described above in relation with the PFM device 1 equally apply to the method 7 having corresponding features.

A processor or processing circuitry of the PFM device 1 may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors.

The PFM device 1 may further comprise memory circuitry, which stores one or more instruction(s) that can be executed by the processor or by the processing circuitry, in particular under control of the software. For instance, the memory circuitry may comprise a non-transitory storage medium (not shown) storing a computer program (i.e., executable program code) which, when executed by the processor or the processing circuitry, causes the method 7 according to the second aspect or any of its embodiments to be performed.

The subject-matter defined below has been described in conjunction with various examples as well as implementations. However, other variations can be understood and effected by those persons skilled in the art and practicing the claimed subject-matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A program flow monitoring (PFM) device for a gateway (GW) device, the PFM device comprising:
a configurable functional state machine (FSM) configured to model a behavior of a monitored processing stage of the GW device; and
processing circuitry configured to:
predicting an expected behavior of the monitored processing stage based on an input of the monitored processing stage and the modeled behavior;
comparing the expected behavior with an actual behavior of the monitored processing stage based on an output of the monitored processing stage; and
selectively generating a fault notification based on a result of the comparison.

2. The PFM device of claim 1, wherein the expected behavior comprises a temporal behavior of the monitored processing stage, and the temporal behavior is based on at least one of:
a network topology and configurable expected processing types of the monitored processing stage,
configurable expected processing times and margins of the expected processing types, and
actual processing types and actual frame types as given by the input of the monitored processing stage.

3. The PFM device of claim 1, wherein the expected behavior comprises a logical behavior of the monitored processing stage, and the logical behavior is based on an error control coding of the input of the monitored processing stage.

4. The PFM device of claim 1, the processing circuitry being further configured to:
associate a respective generated fault notification with a response.

5. The PFM device of claim 4, wherein the response comprises routing the generated fault notification to an output terminal of the PFM device.

6. The PFM device of claim 5, wherein the response further comprises forwarding the generated fault notification on a differential signaling transmission line connected to the output terminal.

7. The PFM device of claim 1, the processing circuitry being further configured to:
inject an error into the input of the monitored processing stage used by the FSM for prediction.

8. The PFM device of claim 7, wherein the injected error comprises an inverted input of the monitored processing stage.

9. The PFM device of claim 1, wherein a further processing stage corresponding to an unmonitored processing stage of the GW device adjoins the monitored processing stage.

10. The PFM device of claim 1, the processing circuitry being further configured to:
receive a clock supply different from a clock domain of the GW device.

11. The PFM device of claim 1, wherein the processor is further configured to execute the instructions in the memory to facilitate the following:
receiving a voltage supply different from of a voltage domain of the GW device.

12. A method of operating a program flow monitoring (PFM) device for a gateway (GW) device, the PFM device comprising a configurable functional state machine (FSM) configured to model a behavior of a monitored processing stage of the GW device, the method comprising:
predicting, by the PFM device, an expected behavior of the monitored processing stage based on an input of the monitored processing stage and the modeled behavior;
comparing, by the PFM device, the expected behavior with an actual behavior of the monitored processing stage based on an output of the monitored processing stage; and
selectively generating, by the PFM device, a fault notification based on a result of the comparison.

13. The method of claim 12, wherein the expected behavior comprises a temporal behavior of the monitored processing stage, and the temporal behavior is based on at least one of:
a network topology and configurable expected processing types of the monitored processing stage,
configurable expected processing times and margins of the expected processing types, and
actual processing types and actual frame types as given by the input of the monitored processing stage.

14. A non-transitory computer readable medium having processor-executable instructions stored thereon, wherein the processor-executable instructions, upon execution by a processor of a program flow monitoring (PFM) device comprising a configurable functional state machine (FSM) configured to model a behavior of a monitored processing stage of the GW device, cause the processor to perform a method comprising:
predicting, an expected behavior of the monitored processing stage based on an input of the monitored processing stage and the modeled behavior;
comparing, the expected behavior with an actual behavior of the monitored processing stage based on an output of the monitored processing stage; and
selectively generating, a fault notification based on a result of the comparison.
